(19) United States
(12) Patent Application Publication
(10) Pub. No.: US 2005/0281219 A1
(43) Pub. Date: Dec. 22, 2005

(54) Method and apparatus for data transmission/scheduling for uplink packet data service in a mobile communication system

(75) Inventors: Young-Bum Kim, Seoul (KR); Ju-Ho Lee, Suwon-Si (KR); Youn-Hyoung Heo, Suwon (KR); Yong-Jun Kwak, Yongin-si (KR); Joon-Young Cho, Suwon-si (KR); Kook-Heui Lee, Yongin-si (KR); Sung-Ho Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/153,490

(22) Filed: Jun. 16, 2005

(30) Foreign Application Priority Data
Jun. 16, 2004 (KR) 46328/2004
Oct. 14, 2004 (KR) 82316/2004

(51) Int. Cl. H04Q 7/00

(52) U.S. Cl. 370/328

(57) ABSTRACT

A method and apparatus are provided for scheduling uplink data transmission in a mobile communication system. The method and apparatus include a base station scheduler for efficiently allocating radio communication resources in a mobile communication system using an E-DCH or DCH. The method and apparatus further include a User Equipment (UE) for using both an E-DCH and a conventional DCH to efficiently select the data rate of the E-DCH and the data rate of the conventional DCH. The method and apparatus can maintain the total transmit power of the UE at the time of retransmission the same as the total transmit power of the UE at the time of initial transmission regardless of the existence or absence of the DCH, thereby minimizing the change in the quantity of interference generated in the uplink by the UE.

### PRIORITY

This application claims the benefit under 35 U.S.C. 119(a) of applications entitled “Method And Apparatus For Data Transmission/Scheduling For Uplink Packet Data Service In Mobile Communication System” filed in the Korean Industrial Property Office on Jun. 16, 2004 and assigned Ser. No. 2004-46328 and on Oct. 14, 2004 and assigned Ser. No. 2004-82316, the entire contents of which are hereby incorporated by reference.

### BACKGROUND OF THE INVENTION

1. Field of the Invention

The present invention relates to a cellular Code Division Multiple Access (CDMA) communication system. More particularly, the present invention relates to a method and apparatus for efficient data transmission/scheduling of an enhanced uplink dedicated transport channel.

2. Description of the Related Art

The Universal Mobile Telecommunication Service (UMTS) system is a third generation (3G) mobile communication system which uses a Wideband Code Division Multiple Access (WCDMA) scheme based on the General Packet Radio Services (GPRS) and Global System for Mobile Communications (GSM) which is a European mobile communication system. The UMTS system provides constant service which can transmit packet-based text, digitalized voice or video and multimedia data at a high speed of at least 2 Mbps.

In the UMTS system, an Enhanced Uplink Dedicated Channel (EUDCH or E-DCH) is used to enhance the performance of packet transport in the uplink (UL) communication, that is, the communication in the backward or reverse direction from a User Equipment (UE) to a Base Station (BS) or a Node B (hereinafter, referred to as only “Node B”). The E-DCH supports various technologies such as an Adaptive Modulation and Coding (AMC) scheme, a Hybrid Automatic Retransmission Request (HARQ) scheme and a base station control scheduling, in order to achieve data transmission at a more stable speed.

The AMC scheme is a technology is used to enhance the efficiency of radio resources by determining the modulation scheme and the coding scheme of the data channel according to the channel state between the node B and the UE. A Modulation and Coding Scheme (MCS) is a combination of a modulation scheme and a coding scheme and provides various MCS levels which can be defined according to supportable modulation schemes and coding schemes. That is to say, the AMC adaptively determines the MCS level according to the channel state between the node B and the UE, so as to enhance the efficiency of the radio frequency.

The HARQ scheme is a technology of re-transmitting a packet in order to compensate for packet error when the previously transmitted data packet has an error. The HARQ scheme can be classified into a Chase Combining (CC) scheme and an Incremental Redundancy (IR) scheme. According to the CC scheme, packets of the same format as that of the previously transmitted packet are re-transmitted when the previously transmitted data packet has an error. According to the IR scheme, packets having a format different from that of the previously transmitted packet are re-transmitted when the previously transmitted data packet has an error.

According to the base station control scheduling, a node B determines whether to transmit uplink data and a possible upper limit for the data rate when transmitting the data by using the E-DCH, and the UE determines the data rate for the uplink E-DCH by referring to the determined information transmitted from the node B to the UE for scheduling and transmits data at the determined data rate.

FIG. 1 is a diagram illustrating uplink packet transmission through E-DCHs in a conventional wireless communication system.

In FIG. 1, reference numeral 100 designates a node B supporting E-DCHs and reference numerals 101, 102, 103 and 104 designate UEs using the E-DCHs. As shown, the UEs 101 through 104 transmit data to node B 100 through the E-DCHs 111, 112, 113 and 114.

The node B 100 utilizes the data buffer state, requested data rate or channel state information of the UEs 101 through 104 using the E-DCH in performing a scheduling operation to adjust the E-DCH data rate or reporting to each UE if it is possible to transmit E-DCH data. In the scheduling as described above, in order to enhance the performance of the entire system, lower data rates are allocated to UEs located far from the node B (e.g. UEs 103 and 104) and higher data rates are allocated to UEs located near to the node B (e.g. UEs 101 and 102) while measured noise rise or Rise over Thermal (RoT) value is prevented from exceeding a target value.

FIG. 2 is a message flow diagram illustrating a conventional process of signal transmission/reception through a E-DCH.

In step 202, the node B and the UE sets up a E-DCH. The set up step 202 includes transmission of messages through dedicated transport channels. After the setup of the E-DCH, the UE reports scheduling information to the node B in step 204. The scheduling information may be uplink channel information including UE transmit power information, information on remaining power which can be transmitted by the UE, the quantity of data accumulated in a buffer of the UE for transmission, etc.

Upon receiving the scheduling information from multiple UEs being in communication, the node B monitors the scheduling information from the multiple UEs in order to schedule the data transmission of each UE in step 206. Specifically, the node B approves uplink packet transmission of the UE and transmits scheduling assignment information to the UE in step 208. The scheduling assignment information includes information about allowed data rate, timing allowed for the transmission, etc.

The UE determines the Transport Format (TF) of the E-DCH to be transmitted uplink by using the scheduling assignment information in step 210, transmits uplink packet data through the E-DCH in step 212, and transmits the TF information to the node B through the E-DCH in step 214. The TF information includes a Transport Format Resource Indicator (TFRI) indicating the information necessary for demodulating the E-DCH. When transmitting the TF information in step 214, the UE selects a MCS level based on the data rate and channel state assigned to the UE by the node B and transmits uplink packet data based on the selected MCS level.

In step 216, the node B determines if the TF information or the packet data has an error. In step 218, through an ACK/NACK channel, the node B transmits Negative Acknowledgement (NACK) information when any of the TF information and the packet data has an error and transmits Acknowledgement (ACK) information when neither of the TF information and the packet data has an error. When the ACK information implying success of the transmission of the packet data is transmitted, the UE transmits new E-DCH data through the E-DCH. When the NACK information is transmitted, the UE re-transmits the E-DCH data having the same content through the E-DCH.

In the conventional process as described above, the node B measures and estimates the total of the RoT used in a cell and allocates the unused extra RoT for the E-DCH within a range of the maximum RoT allowable in the cell. Here, the RoT implies an uplink resource used by the node B.

In order to improve the performance of the system, it is necessary to optimize the extra RoT such as the resource which can be allocated for the E-DCH. For such optimization, a method for reasonably measuring and estimating the total of the RoT currently being used. According to the conventional method, the total of the RoT currently being used may be measured and estimated to be excessively high, so that assignable resources may be excessively reduced and the performance of the entire system can be degraded. Moreover, there has been disclosed no method for efficient allocation of resources between the D-DCH and the DCH which simultaneously exist as uplink channels. Therefore, it is difficult to provide a satisfactory service quality for the existing DCH.

### SUMMARY OF THE INVENTION

Accordingly, the present invention has been made to solve the above-mentioned problems occurring in the prior art, and an object of the present invention is to provide a method and apparatus by which a base station scheduler can efficiently allocate radio communication resources in a mobile communication system using an enhanced uplink dedicated transport channel.

It is another object of the present invention to provide a method and apparatus by which a User Equipment (UE) using both an enhanced uplink dedicated transport channel and a conventional dedicated transport channel can efficiently select the data rate of the enhanced uplink dedicated transport channel and the data rate of the typical dedicated transport channel.

It is another object of the present invention to provide a method and apparatus by which the data rate for a User Equipment (UE) using both an enhanced uplink dedicated transport channel and a conventional dedicated transport channel can be determined without being limited to the dedicated transport channel.

It is another object of the present invention to provide a method and apparatus which can maintain the total transmit power of the UE at the time of retransmission as at the time of initial transmission regardless of the existence or absence of the DCH, thereby minimizing the change in the quantity of interference generated in the uplink by the UE.

In order to accomplish this object, there is provided a method for scheduling uplink data transmission in a mobile communication system supporting an uplink packet data service via a first channel and a second channel. The method comprising the steps of determining an average data rate for the first channel; determining a maximum data rate of the second channel based on a difference between the total radio resource and a radio resource corresponding to the determined average data rate of the first channel; and transmitting scheduling assignment information indicating the determined maximum data rate to a User Equipment (UE), wherein the second channel is subjected to scheduling and the first channel is not subjected to scheduling.

In accordance with another aspect of the present invention, there is provided an apparatus for scheduling uplink data transmission in a mobile communication system supporting an uplink packet data service via a first channel and a second channel. The apparatus comprising a scheduling signal generator for determining an average data rate expected to be used for the first channel, determining a maximum data rate of the second channel based on a difference between the total radio resource and a radio resource corresponding to the determined average data rate of the first channel, and generating a scheduling signal indicating the determined maximum data rate; a scheduling signal transmitter for transmitting the generated scheduling signal to a User Equipment (UE); and a scheduling signal transmission controller for controlling the scheduling signal generator and the scheduling signal transmitter so that the scheduling signal can be transmitted at a predetermined scheduling period, wherein the second channel is subjected to scheduling and the first channel is not subjected to scheduling.

In accordance with another aspect of the present invention, there is provided a method for transmitting uplink data in a mobile communication system supporting an uplink packet data service. The method comprising the steps of receiving scheduling assignment information indicating a maximum data rate for a first channel and a second channel; determining a data rate for the first channel based on the maximum data rate; determining a data rate for the second channel based on a difference between the maximum data rate and the data rate of the first channel; and transmitting the uplink data of the first channel and the second channel using the determined data rates, wherein the second channel is subjected to scheduling and the first channel is not subjected to scheduling. In accordance with another aspect of the present invention, there is provided an apparatus for transmitting uplink data in a mobile communication system supporting an uplink packet data service. The apparatus comprising a scheduling assignment information receiver for receiving scheduling assignment information indicating a maximum data rate for a first channel and a second channel; a controller for determining a data rate for the first channel based on the maximum data rate and determining a data rate for the second channel based on a difference between the maximum data rate and the data rate available of the first channel; and a transmitter for transmitting the uplink data of the first channel and the second channel using the determined data rate, wherein the second channel is subjected to scheduling and the first channel is not subjected to scheduling.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating uplink packet transmission through Enhanced Uplink Dedicated Channels (E-DCHs) in a conventional wireless communication system;

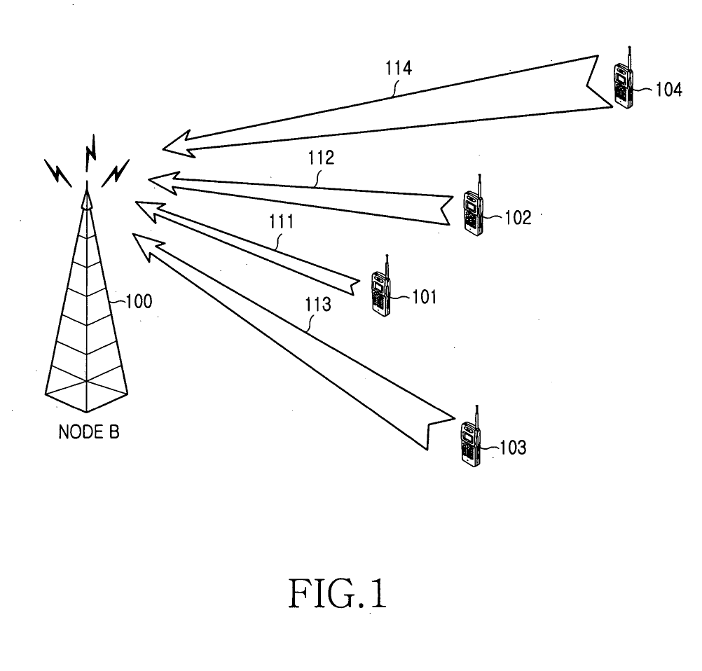

FIG. 2 is a message flow diagram illustrating a conventional process of signal transmission/reception through a E-DCH;

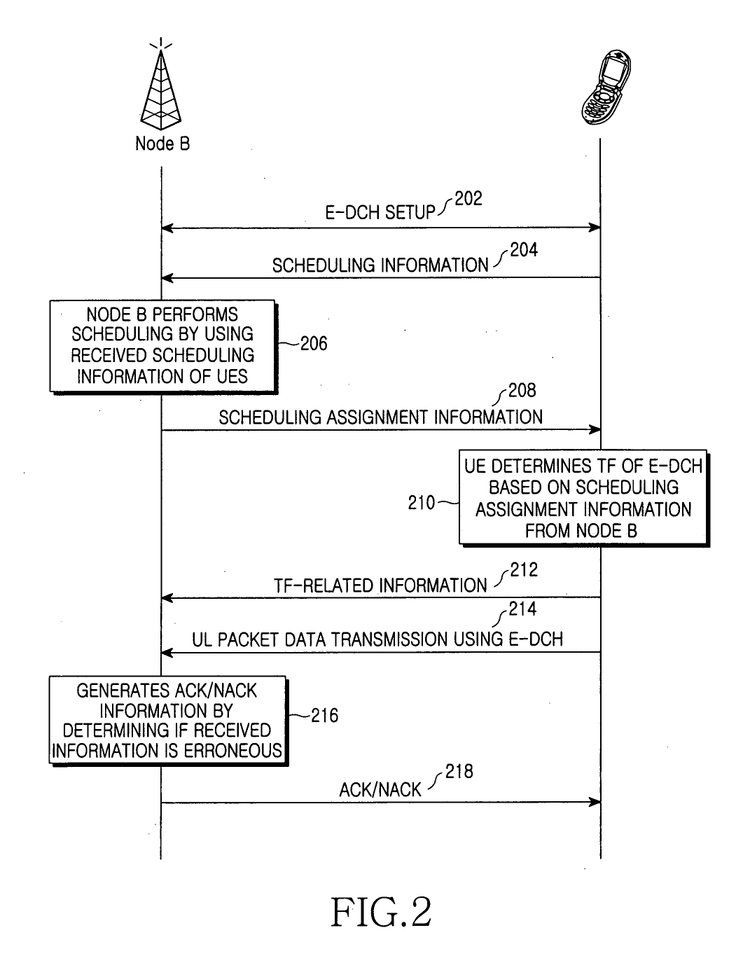

FIG. 3 is a flow diagram of a process in which a node B generates a scheduling command for each user equipment (UE) according to an embodiment of the present invention;

FIG. 4 is a flowchart of a process in which a UE determines the data rate according to an embodiment of the present invention;

FIG. 5 is a flowchart of a process for determining the transmit power by the UE according to an embodiment of the present invention;

FIG. 6 is a block diagram illustrating a structure of an apparatus for transmitting scheduling assignment information of a node B according to an embodiment of the present invention; and

FIG. 7 is a block diagram of an apparatus for determining the data rate of a UE and controlling the transmit power of the UE according to an embodiment of the present invention.

### DETAILED DESCRIPTION OF EXEMPLARY EMBODIMENTS

Hereinafter, embodiments of the present invention will be described with reference to the accompanying drawings. In the following description, a detailed description of known functions and configurations incorporated herein will be omitted when it may make the subject matter of the present invention rather unclear. Further, various specific terms found in the following description are defined in consideration of the functions in the present invention and can be changed according to intentions of users and operators or customs. Therefore, definitions of such terms must be based on the matters in the entire specification of the present invention.

The core of the present invention lies in an improvement in uplink packet data service of a mobile communication system. For convenience of description, uplink Dedicated Channel (DCH) and Enhanced Uplink Dedicated Channel (E-DCH) are discussed. As used herein, the transmit power and data rate have generally one-to-one relation. Thus, both of them will be used in the following description.

First, in order to prevent such inefficient use of resources by a node B as described above, a method for reasonably measuring and estimating the sum of the resources used in a cell is necessary. That is to say, the amount of resources which can utilized by a node B as RoT for user equipments (UEs) which will use the E-DCHs in a cell corresponds to the difference between the maximum RoT allowable in the cell and the total of RoT used in the cell. The information about the maximum RoT allowable in the cell is signaled to the node B from a Radio Network Controller (RNC).

The total of RoT used in the cell includes RoT by the DCH and RoT by other channels. In the case of DCH, the UE selects a Transport Format Combination (TFC) corresponding to the data rate (or transmit power) of the DCH from the Transport Format Combination Set (TFCS) signaled from the node B. Therefore, the node B cannot have a preliminary knowledge of an exact data rate (or transmit power) of each UE at a particular time point. Therefore, it is difficult to perform exact estimation of the RoT by the DCH. The only thing the node B can understand from the maximum data rate (or transmit power) allowed for each UE is the RoT corresponding to the data rate (or transmit power).

If the node B calculates the RoT used in the cell in consideration of the maximum data rate (or transmit power) allowed for each UE, the RoT resource assignable to the E-DCH is reduced. It is because the DCH transmitted by each UE is not always transmitted with the maximum data rate (or transmit power) within the TFCS signaled fro the node B. Therefore, the embodiments of the present invention provide a method using a statistical characteristic for the DCH data rate (or transmit power) of each UE in order to reasonably estimate the DCH RoT used in a cell.

The RNC can understand the statistical characteristic for the data rate (or transmit power) of each UE through a preliminary test or by observing the data rate (or transmit power) of each UE in the cell during a predetermined time period. The RNC can estimate an average data rate by using the statistical characteristic and can reasonably predict the DCH RoT based on the average data. A scheduling optimization coefficient αᵢ (0≦αᵢ≦1, wherein αᵢ represents a scheduling optimization coefficient corresponding to the i-th UE) for each UE in order to efficiently utilize the uplink RoT resource is defined as a ratio of an average data rate with respect to the maximum data rate allowed for each UE, and the RNC can reasonably predict the DCH RoT based on the scheduling optimization coefficient αᵢ. The RNC signals the calculated scheduling optimization coefficient or the estimated average data rate corresponding to the calculated scheduling optimization coefficient to the node B, so that the node B can use them in predicting the DCH RoT. The prediction of the DCH RoT is performed by the RNC as an example in the above description. However, according to the selection of the system designer, the node B may predict the DCH RoT.

Hereinafter, a method for estimating a scheduling optimization coefficient according to an embodiment of the present invention will be described.

The scheduling optimization coefficient is a ratio of the DCH average data rate (or transmit power) with respect to the DCH maximum data rate (or transmit power), which can be expressed by equation (1) below:

$$E [ {R}_{DCHi , j} ] = {\sum }_{j} Pr ( {DCH}_{i , j} ) \cdot {R}_{DCHi , j} \cdot {α}_{i} = \frac{E ⌊ {R}_{DCHi , j} ⌋}{{max}_{j} {R}_{DCHi , j}} \qquad ( 1 )$$

In equation (1), i is an index indicating each UE, j is an index indicating each TFC, E└R_{DCHi,j}┘ represents a DCH average data rate (or transmit power) of the i-th UE, Pr(DCH_{i,j}) represents a DCH occurrence probability of the i-th UE having the j-th TFC, R_{DCHi,j} represents a DCH data rate (or transmit power) of the i-th UE having the j-th TFC, and

$${max}_{j} {R}_{DCHi , j}$$

represents an allowed DCH maximum data rate (or transmit power) of the i-th UE having the j-th TFC.

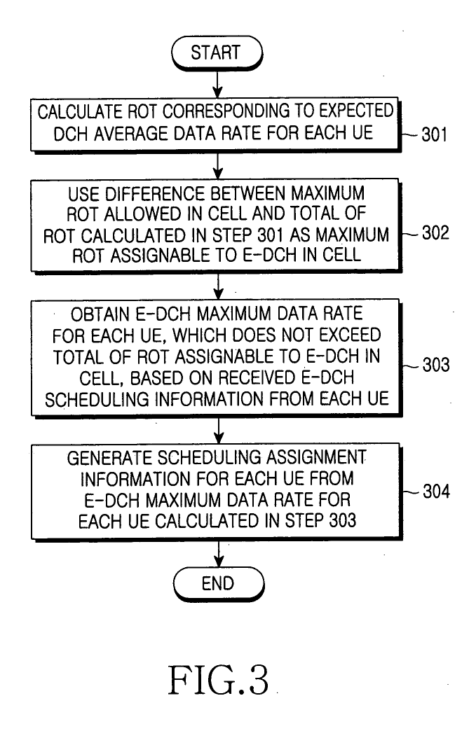

FIG. 3 is a flow diagram of a process in which a node B generates a scheduling command for each UE according to an embodiment of the present invention.

In step 301, the node B calculates the RoT corresponding to an expected DCH average data rate (or transmit power) for each UE. The RoT corresponds to a product obtained by multiplying the scheduling optimization coefficient for each UE by the DCH maximum data rate (or transmit power) for each UE. By using the scheduling optimization coefficient as described above, it is possible to prevent waste of the RoT, which may be caused by calculating the RoT being used in the cell as too much. It is also possible to calculate the RoT by other uplink common channels.

In step 302, the node B uses the difference between the maximum RoT allowed in the cell and the total of the RoT calculated in step 301 as a maximum RoT assignable to the E-DCH in the cell. The total of the RoT calculated in step 301 represents the RoT total for the DCH and E-DCH and may comprise a RoT total for common channels. In general, the RoT allocated to control channels relating to data channels and common channels is fixed in advance or determined based on the RoT allocated to the corresponding data channels. Therefore, only the radio resources allocated to the uplink data channels will be discussed in the present specification. The maximum RoT allowed in the cell is a value signaled from the RNC to the node B.

In step 303, the node B obtains a E-DCH maximum data rate (or transmit power) for each UE, which does not exceed the total of the RoT assignable to the E-DCH in the cell, based on the received E-DCH scheduling information from each UE.

In step 304, the node B generates scheduling assignment information for each UE, which comprises the E-DCH maximum data rate for each UE calculated in step 303. The scheduling assignment information is representative of maximum data rate for E-DCH and DCH. For example, the scheduling assignment information may be expressed as one of the following types of information.

The information No. 1 indicates ‘the maximum transmissible total data rate of each UE comprising DCH and E-DCH’. That is, the UE determines the DCH data rate and the E-DCH data rate within the total data rate.

The information No. 2 indicates ‘the maximum E-DCH data rate of each UE’ in step 303 in FIG. 3 and ‘the scheduling optimization coefficient of each UE’. Each UE can obtain the same information as the information No. 1 by calculating ‘a sum of the E-DCH maximum data rate and the product obtained by multiplying the scheduling optimization coefficient by the DCH maximum data rate’. The DCH maximum data rate is a value signaled from the RNC to the UE.

The information No. 3 indicates ‘the DCH average data rate expected for transmission of each UE’ in step 301 of FIG. 3 and ‘the E-DCH maximum data rate for each UE’ such as the value calculated in step 303. Each UE can obtain the same information as the information No. 1 from the two values.

The information No. 4 indicates ‘the sum of the DCH maximum data rate and the E-DCH maximum data rate for each UE’. The E-DCH maximum data rate is a value calculated in consideration of not the DCH average data rate but the DCH maximum data rate for each UE.

The information No. 5 indicates ‘the E-DCH maximum data rate’. The E-DCH maximum data rate is a value calculated in consideration of not the DCH average data rate but the DCH maximum data rate for each UE. The UE generates the information No. 4 by using the information No. 5 and the TFCS signaled from the node B.

Each UE can understand ‘the maximum transmissible data rate of each UE comprising the DCH and E-DCH’. If each transport channel is assigned the maximum transmissible data rate, other channels cannot use the remaining data rate after use of the data rate by each transport channel, so that it is impossible to achieve efficient utilization of resources. However, if each UE has a knowledge of ‘the maximum transmissible data rate of each UE comprising the DCH and E-DCH’, it can flexibly determine the DCH and E-DCH data rate within the maximum transmissible data rate, thereby achieving efficient utilization of resources. Further, from the information No. 4 or No. 5, the UE can flexibly determine the DCH and E-DCH data rate within the maximum transmissible data rate, thereby achieving efficient utilization of resources.

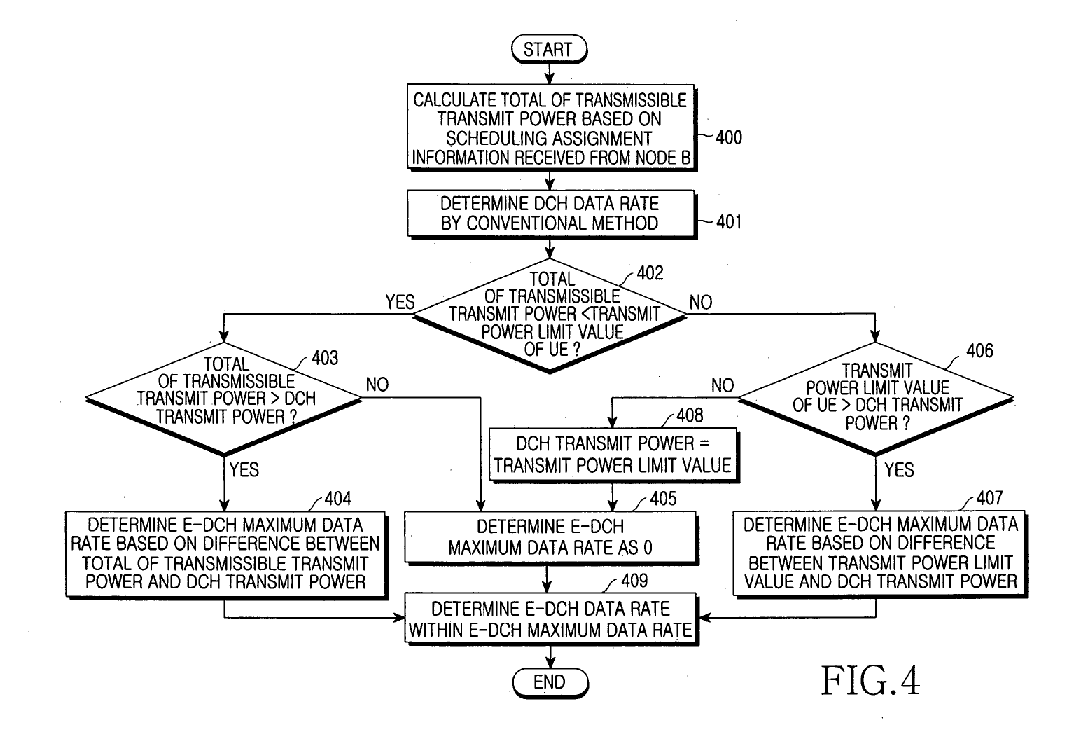

FIG. 4 is a flowchart of a process in which a UE determines the data rate according to an embodiment of the present invention.

In step 400, the UE receives scheduling assignment information (or total of transmissible transmit power) or receives scheduling assignment information and calculates the total of transmissible transmit power based on the received scheduling assignment information from the node B. The total of the transmit power comprises the quantity of the DCH data in a buffer of the UE, the currently usable transmit power, the currently usable TFCS and the capability of the UE.

In step 401, the UE determines the data rate of the DCH. In general, the DCH has as high a priority as the voice data. Therefore, the data rate of the DCH is determined regardless of the existence or absence of the E-DCH. That is, the data rate (or transmit power) of the DCH is determined in consideration of the total of the transmit power which can be transmitted by the UE within the TFCS signaled from the node B.

In step 402, the UE compares the total of the transmit power (the maximum transmissible data rate of the UE comprising the assigned DCH and E-DCH) with the transmit power limit value of the UE. The transmit power limit value of the UE is an upper limit of the transmit power which the power amplifier can allow, and it is physically impossible to achieve transmission with a power exceeding the transmit power limit value. As a result of the comparison, when the total of the transmit power is less than the transmit power limit value of the UE, the UE proceeds to step 403.

In step 403, the UE compares the total of the transmit power with a transmit power corresponding to the DCH data rate determined in step 401. When the total of the transmit power is larger than the transmit power corresponding to the DCH data rate determined in step 401, the UE determines the difference between the total of the transmit power and the transmit power corresponding to the DCH data rate as the E-DCH maximum data rate in step 404 and proceeds to step 409. In step 409, the UE determines the E-DCH data rate within the E-DCH maximum data rate.

As a result of the determination in step 403, when the total of the transmit power is less than or equal to the transmit power corresponding to the DCH data rate determined in step 401, the UE proceeds to step 405. In step 405, in consideration of the fact that there left no usable transmit power, the UE determines the E-DCH maximum data rate as 0. Then, in step 409, the UE transmits no data through the E-DCH.

As a result of the determination in step 402, when the total of the transmit power (the maximum transmissible data rate of the UE comprising the assigned DCH and E-DCH) is greater than or equal to the transmit power limit value of the UE, the UE proceeds to step 406.

In step 406, the UE compares the transmit power limit value of the UE with the transmit power corresponding to the DCH data rate determined in step 401. When the transmit power limit value of the UE is larger than the transmit power corresponding to the DCH data rate determined in step 401, the UE proceeds to step 407. When the transmit power limit value of the UE is smaller than or equal to the transmit power corresponding to the DCH data rate determined in step 401, the UE proceeds to step 408.

In step 407, the UE determines the difference between the transmit power limit value and the transmit power corresponding to the DCH data rate determined by the UE as the E-DCH maximum data rate. Then, in step 409, the UE determines the E-DCH data rate within the E-DCH maximum data rate.

It is impossible to determine the DCH data rate as a value exceeding the transmit power limit value. Therefore, it is necessary to adjust the transmit power of the DCH. Therefore, in step 408, the UE sets the DCH data rate as ‘the transmit power limit value’. Then, the UE proceeds to step 405. In step 405, in consideration of the fact that there left no usable transmit power, the UE determines the E-DCH maximum data rate as 0. Then, in step 409, the UE transmits no data through the E-DCH.

In the situation in which data are transmitted at the data rate of the DCH and E-DCH determined through the process described above, it may be necessary to retransmit the E-DCH through the HARQ operation. In this case, when only the E-DCH exists without the DCH at the time of the retransmission, the power which would be occupied by the DCH when the DCH exists can be added to the power allocated to the E-DCH, so that the total transmit power level generated by the UE can be maintained constant and the base station scheduler can stably operate. That is, the transmit power Tx_power_E-DCH set for the E-DCH at the time of retransmission can be expressed as a sum of the transmit power Tx_power_E-DCH_init used for the E-DCH in the initial transmission and the transmit power Tx_power_DCH_init used for the DCH in the initial transmission as shown Equation (2) below:
Tx_{—}power_{—}E-DCH=Tx_{—}power_{—}E-DCH_{—}init+Tx_{—}power_{—}DCH_{—}init (2)

Further, when only the E-DCH is transmitted at the initial transmission and the DCH is generated at the time of retransmitting the E-DCH by the HARQ operation, the transmit power of the generated DCH is set to have a value corresponding to the DCH data rate, and a value obtained by subtracting the DCH transmit power from the transmit power allocated to the E-DCH at the time of initial transmission is set as the E-DCH transmit power at the time of retransmission. Therefore, the total transmit power level of the UE at the time of retransmission can be maintained the same as the total transmit power level of the UE at the time of initial transmission, and the base station scheduler can be stably operated. That is, the transmit power Tx_power_E-DCH set for the E-DCH at the time of retransmission can be expressed as the difference between the transmit power Tx_power_E-DCH_init used for the E-DCH in the initial transmission and the transmit power Tx_power_DCH allocated to the DCH which does not exist in the initial transmission and occurs at the time of retransmission, as shown Equation (3) below:
Tx_{—}power_{—}E-DCH=Tx_{—}power_{—}E-DCH_{—}init−Tx_{—}power_{—}DCH (3)

From Equations (2) and (3), the transmit power Tx_power_E-DCH set for the E-DCH at the time of retransmission can be generalized as shown in Equation (4) below.
Tx_{—}power_{—}E-DCH=Tx_{—}power_{—}E-DCH_{—}init+Δ_{—}release−Δ_{—}add (4)

In other words, the transmit power Tx_power_E-DCH set for the E-DCH at the time of retransmission corresponds to a value obtained by adding extra power (Δ_release) to the transmit power Tx_power_E-DCH_init used for the E-DCH at the time of the initial transmission and then subtracting a transmit power (Δ_add) from the sum. Here, the extra power (Δ_release) refers to the power caused due to absence of the DCH at the time of retransmission, and the transmit power (Δ_add) refers to the transmit power of the added channel which is absent in the initial transmission and occurs in the retransmission.

The above description discusses a method of setting the E-DCH transmit power in consideration of the initial transmission and retransmission of the E-DCH. However, when the retransmission of the E-DCH is performed more than once, it is possible to determine the E-DCH transmit power whenever additional retransmissions are performed. For example, in the case of performing a maximum four retransmissions, either when the DCH exists in the first and second retransmission but does not exist in the third retransmission or when the DCH does not exist in the first retransmission but exists in the second retransmission, the transmit power for the retransmission of the E-DCH can be set by using Equation (4).

In the embodiments described above, the DCH transmit power is reflected in the set up of the transmit power for the retransmission of the E-DCH. However, according to another embodiment, it is possible to employ an adaptive application within the range of the DCH transmit power in consideration of the E-DCH data rate. For example, when it is necessary to increase the transmit power for the retransmission of the E-DCH, that is, when no DCH exists in the retransmission of the E-DCH and the E-DCH has a high data rate, all of the transmit power used for the DCH is applied to the set up of the transmit power of the E-DCH. In contrast, when the E-DCH has a low data rate, a part of the transmit power used for the DCH may be applied to the set up of the transmit power of the E-DCH or the E-DCH may be transmitted while maintaining the previous DCH transmit power.

After the UE determines the data rate of the DCH and E-DCH, the corresponding instant transmit power of the UE may increase. For example, when the channel state is degraded, the transmit power of the UE may be instantly increased by the power control operation. Therefore, a process according to another embodiment of the present invention, in which the UE determines the transmit power of the DCH and E-DCH in consideration of the instant transmit power and the transmit power limit value, will be described below.

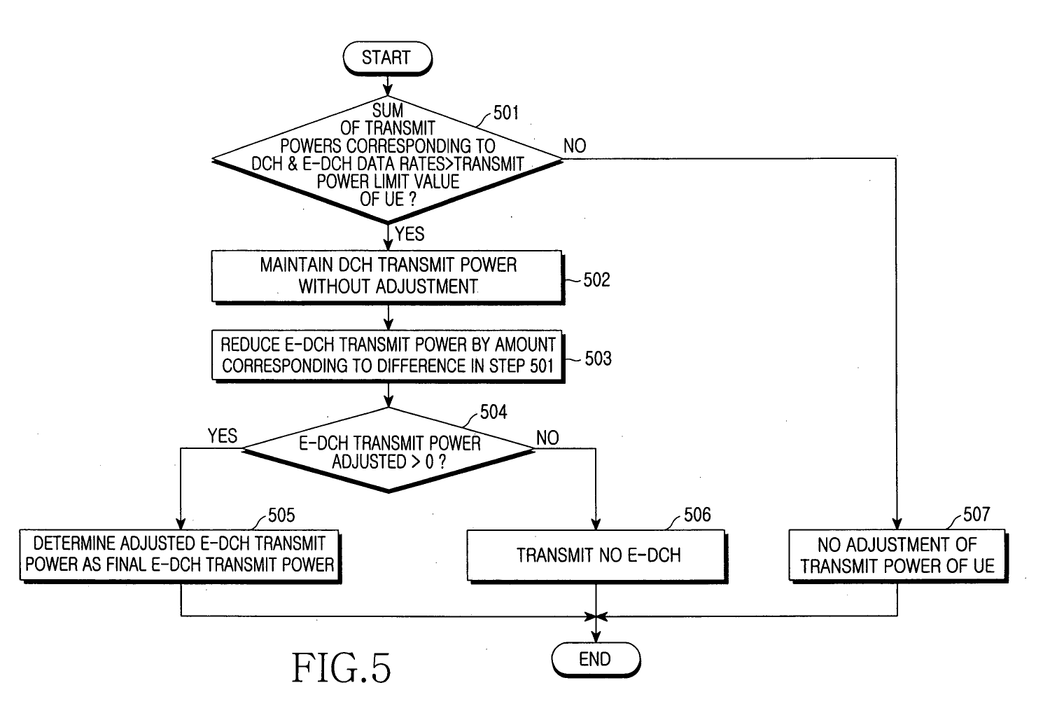

FIG. 5 is a flowchart of a process for determining the transmit power by the UE according to an embodiment of the present invention.

In step 501, the UE determines if ‘the sum of instant transmit power corresponding to the DCH and E-DCH data rates’ exceeds ‘the transmit power limit value’ of the UE, which is the upper limit of the transmit power which the power amplifier of the UE can allow.

As a result of the determination, when ‘the sum of instant transmit power corresponding to the DCH and E-DCH data rates’ does not exceed ‘the transmit power limit value’ of the UE, the UE proceeds to step 507 in which the UE does not adjust the transmit power.

As a result of the determination, when the sum exceeds the transmit power limit value, the UE maintains the transmit power for the DCH by giving priority to the DCH in step 502 and readjusts the transmit power of the E-DCH in step 503. As a result, the DCH-related operations are minimally influenced by the E-DCH. Specifically, the transmit power for the E-DCH is readjusted by being reduced as much as the difference between ‘the sum of instant transmit power corresponding to the DCH and E-DCH data rates’ and ‘the transmit power limit value’. That is, the UE reduces the transmit power of the E-DCH as much as the portion of the entire transmit power of the DCH and E-DCH exceeding the transmit power limit value.

In step 504, the UE determines if the adjusted E-DCH transmit power has a positive value. When the adjusted E-DCH transmit power has a positive value, the UE proceeds to step 505. In step 505, the UE transmits the E-DCH at the data rate corresponding to the adjusted E-DCH transmit power value.

When the adjusted E-DCH transmit power does not have a positive value as a result of the determination in step 504, the UE proceeds to step 506. Because the transmit value cannot have a negative value, the UE does not transmit the E-DCH in step 506.

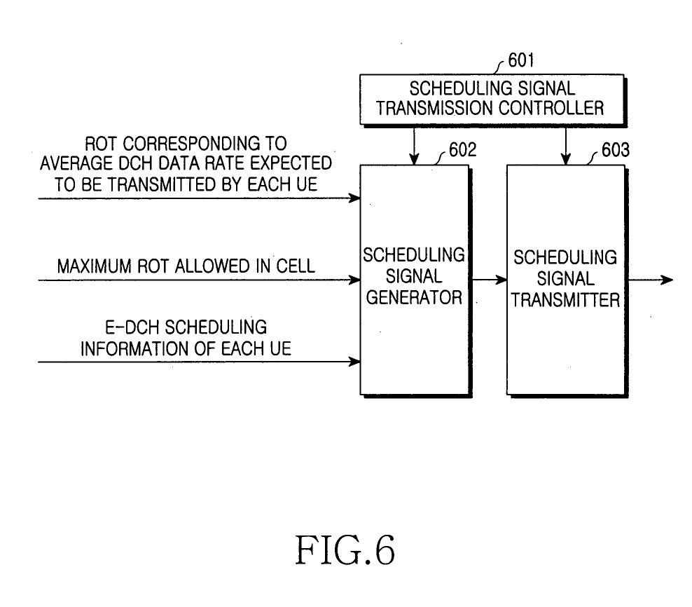

FIG. 6 is a block diagram illustrating a structure of an apparatus for transmitting scheduling assignment information of a node B according to an embodiment of the present invention.

Referring to FIG. 6, a base station scheduler comprises a scheduling signal transmission controller 601, a scheduling signal generator 602 and a scheduling signal transmitter 603.

The scheduling signal transmission controller 601 controls the scheduling signal generator 602 and the scheduling signal transmitter 603 so that the scheduling signal can be transmitted at the predetermined scheduling period.

The scheduling signal generator 602 generates a scheduling signal in consideration of the RoT corresponding to the DCH average data rate expected to be transmitted by each UE, the maximum RoT allowed in the cell and the E-DCH scheduling information of each UE. Here, the RoT corresponding to the DCH average data rate expected to be transmitted by each UE may be signaled from the RNC to the node B. Otherwise, the RoT corresponding to the DCH average data rate expected to be transmitted by each UE can be calculated by the node B from the DCH maximum data rate allowed for each UE signaled from the RNC to the node B and the scheduling optimization coefficient of each UE signaled from the RNC to the node B. The maximum RoT allowed in the cell is a value signaled from the RNC to the node B. Further, the node B can calculate the RoT corresponding to the average DCH data rate and the scheduling optimization coefficient of each UE. The operation of generating the scheduling command for each UE is performed by the scheduling signal generator 602. The scheduling signal transmitter 603 codes and modulates the generated scheduling signal and then the coded and modulated signal through the scheduling channel.

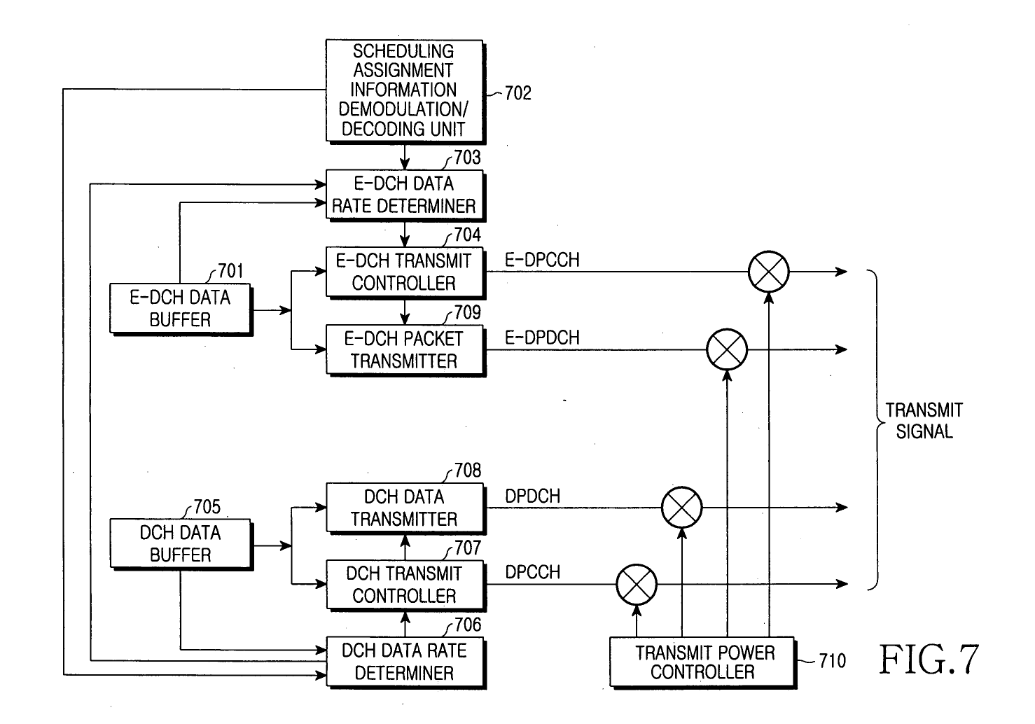

FIG. 7 is a block diagram of an apparatus for determining the data rate of a UE and controlling the transmit power of the UE according to an embodiment of the present invention.

Referring to FIG. 7, the UE receives the scheduling assignment information from the node B and demodulates/decodes the received scheduling assignment information in the scheduling assignment information demodulation/decoding unit 702, thereby acquiring the scheduling assignment information. Here, the scheduling assignment information comprises at least one of the information No. 1, information No. 2, information No. 3, information No. 4 and information No. 5 as described above.

The UE determines ‘the maximum transmissible data rate (or transmit power) of the UE comprising the DCH and U-DCH’ from the scheduling assignment information. Because the data rate of the DCH is determined regardless of the existence or absence of the E-DCH, the DCH data rate determiner 706 determines the DCH data rate in consideration of ‘the maximum transmissible data rate (or transmit power) of the UE comprising the DCH and U-DCH’, the quantity of data in the buffer of the UE, the currently usable TFCS, the capability of the UE, etc. The DCH data rate determiner 706 receives information about the quantity of the DCH data in the buffer of the UE from the DCH data buffer 705 and uses it in order to determine the DCH data rate.

When the DCH data rate has been determined, the DCH transmit controller 707 determines the DCH transport format and applies it to the DCH data transmitter 708. The information about the DCH transport format is transmitted to the UE through a Dedicated Physical Control Channel (DPCCH) for carrying control information for the DCH. The DCH data transmitter 708 takes an appointed quantity of data from the DCH data buffer 705 according to the DCH transport format, performs channel coding and modulation for the taken data, and then transmits the channel-coded and modulated data through a Dedicated Physical Data Channel (DPDCH) which is a physical channel.

The data rate of the E-DCH is determined based on ‘the maximum transmissible data rate (or transmit power) of the UE comprising the DCH and U-DCH’, the DCH data rate (or transmit power) determined in the DCH data rate determiner 706 and the quantity of data in the E-DCH data buffer 701. Specifically, the determination of the E-DCH data rate follows the process described with reference to FIG. 4.

When the E-DCH data rate has been determined, the E-DCH transmit controller 704 determines the E-DCH transport format and applies it to the E-DCH data transmitter 709. The information about the E-DCH transport format is transmitted through an Enhanced Dedicated Physical Control Channel (E-DPCCH) for carrying control information for the E-DCH. The E-DCH data transmitter 709 takes an appointed quantity of data from the E-DCH data buffer 701 according to the E-DCH transport format, performs channel coding and modulation for the taken data, and then transmits the channel-coded and modulated data through an Enhanced Dedicated Physical Data Channel (E-DPDCH) which is a physical channel for the E-DCH.

Meanwhile, the instant transmit power of the UE may increase even beyond ‘the transmit power limit value’ which the power amplifier of the UE can allow. In this case, the transmit power controller 710 adjusts the transmit power of each channel and reflects the adjusted power in the gain factor multiplied to each channel, thereby maintaining the instant transmit power of the UE within ‘the transmit power limit value’. Then, while maintaining the transmit power for the DCH without change, the UE reduces the transmit power for the E-DCH as much as the portion of the entire transmit power exceeding ‘the transmit power limit value’. If the instant transmit power of the UE exceeds ‘the transmit power limit value’ even after reducing the transmit power for the E-DCH, the UE scales the transmit power of the other channels than the E-DCH in the same manner.

The above description discusses only the information No. 1. However, use of the information No. 2 through the information No. 5 can have the same or an equivalent effect in achieving the objects of the present invention.

According to the embodiment of the present invention described above, in the case of using the E-DCH, the base station scheduler can efficiently allocate radio communication resources and the UE can efficiently select the data rates of the E-DCH and DCH. Further, according to this embodiment of the present invention, the total transmit power of the UE at the time of retransmission can be maintained the same as the total transmit power of the UE at the time of initial transmission regardless of the existence or absence of the DCH, so that the change in the quantity of interference generated in the uplink by the UE can be minimized.

Further, in the case of using both the E-DCH and the DCH, when an instant power shortage occurs, the power for the E-DCH can be readjusted while maintaining the power for the DCH.

While the invention has been shown and described with reference to certain embodiments thereof, it will be understood by those skilled in the art that various changes in form and details may be made therein without departing from the spirit and scope of the invention as defined by the appended claims.

1. A method for scheduling uplink data transmission in a mobile communication system supporting an uplink packet data service via a first channel and a second channel, the method comprising the steps of:
determining an average data rate for the first channel;
determining a maximum data rate of the second channel based on a difference between the total radio resource and a radio resource corresponding to
the determined average data rate of the first channel; and
transmitting scheduling assignment information indicating the determined maximum data rate to a User Equipment (UE),
wherein the second channel is subjected to scheduling and the first channel is not subjected to scheduling.

2. The method as claimed in claim 1, wherein the step of determining the maximum data rate of the second channel comprises the steps of:
setting the difference between the radio resources as a radio resource assignable to the second channel; and
determining the maximum data rate of the second channel for the UE while preventing the radio resource assignable to the second channel from exceeding a maximum radio resource assignable to the second channel within a cell.

3. The method as claimed in claim 1, wherein the total radio resource is provided and controlled by a radio network controller.

4. The method as claimed in claim 1, wherein the average data rate of the first channel is calculated by multiplying a maximum data rate for each UE allocated to the first channel by a corresponding scheduling optimization coefficient.

5. The method as claimed in claim 4, wherein the maximum data rate of the first channel and the scheduling optimization coefficient are provided by a radio network controller.

6. The method as claimed in claim 5, wherein the scheduling optimization coefficient corresponds to a ratio of the average data rate of the first channel with respect to the maximum data rate of the first channel.

7. The method as claimed in claim 1, wherein each of the radio resources is expressed by a Rise over Thermal (RoT) corresponding to uplink data rate or transmit power.

8. The method as claimed in claim 1, wherein the scheduling assignment information comprises a maximum transmissible data rate of the UE comprising the data rate of the first channel and the maximum data rate of the second channel.

9. The method as claimed in claim 1, wherein the scheduling assignment information comprises the maximum data rate of the second channel and the scheduling optimization coefficient of the UE.

10. The method as claimed in claim 1, wherein the scheduling assignment information comprises the average data rate of the first channel and the maximum data rate of the second channel.

11. The method as claimed in claim 1, wherein the scheduling assignment information comprises a sum of the maximum data rate of the first channel and the maximum data rate of the second channel.

12. The method as claimed in claim 1, wherein the scheduling assignment information comprises the maximum data rate of the second channel.

13. An apparatus for scheduling uplink data transmission in a mobile communication system supporting an uplink packet data service via a first channel and a second channel, the apparatus comprising:
a scheduling signal generator for determining an average data rate expected to be used for the first channel, determining a maximum data rate of the second channel based on a difference between the total radio resource and a radio resource corresponding to the determined average data rate of the first channel, and generating a scheduling signal indicating the determined maximum data rate;
a scheduling signal transmitter for transmitting the generated scheduling signal to a User Equipment (UE); and
a scheduling signal transmission controller for controlling the scheduling signal generator and the scheduling signal transmitter so that the scheduling signal can be transmitted at a predetermined scheduling period,
wherein the second channel is subjected to scheduling and the first channel is not subjected to scheduling.

14. The apparatus as claimed in claim 13, wherein, when the maximum data rate of the second channel is determined, the difference between the radio resources is set as a radio resource assignable to the second channel, and the maximum data rate of the second channel for the UE is determined to prevent the radio resource assignable to the second channel from exceeding a maximum radio resource within a cell.

15. The apparatus as claimed in claim 13, wherein the total radio resource is provided and controlled by a radio network controller.

16. The apparatus as claimed in claim 13, wherein the average data rate of the first channel is calculated by multiplying a maximum data rate for each UE allocated to the first channel by a corresponding scheduling optimization coefficient.

17. The apparatus as claimed in claim 16, wherein the maximum data rate of the first channel and the scheduling optimization coefficient are provided by a radio network controller.

18. The apparatus as claimed in claim 17, wherein the scheduling optimization coefficient corresponds to a ratio of the average data rate of the first channel with respect to the maximum data rate of the first channel.

19. The apparatus as claimed in claim 13, wherein each of the radio resources is expressed by a Rise over Thermal (RoT) corresponding to uplink data rate or transmit power.

20. The apparatus as claimed in claim 13, wherein the scheduling assignment information comprises a maximum transmissible data rate of the UE comprising the data rate of the first channel and the maximum data rate of the second channel.

21. The apparatus as claimed in claim 13, wherein the scheduling assignment information comprises the maximum data rate of the second channel and the scheduling optimization coefficient of the UE.

22. The apparatus as claimed in claim 13, wherein the scheduling assignment information comprises the average data rate of the first channel and the maximum data rate of the second channel.

23. The apparatus as claimed in claim 13, wherein the scheduling assignment information comprises a sum of the maximum data rate of the first channel and the maximum data rate of the second channel.

24. The apparatus as claimed in claim 13, wherein the scheduling assignment information comprises the maximum data rate of the second channel.

25. A method for transmitting uplink data in a mobile communication system supporting an uplink packet data service, the method comprising the steps of:
receiving scheduling assignment information indicating a maximum data rate for a first channel and a second channel;
determining a data rate for the first channel based on the maximum data rate;
determining a data rate for the second channel based on a difference between the maximum data rate and the data rate of the first channel; and
transmitting the uplink data of the first channel and the second channel using the determined data rates,
wherein the second channel is subjected to scheduling and the first channel is not subjected to scheduling.

26. The method as claimed in claim 25, further comprising the step of reducing the transmit power corresponding to the data rate of the second channel, so as to prevent transmit power corresponding to the data rates of the first channel and the second channel from exceeding the transmit power limit value of the UE.

27. The method as claimed in claim 25, wherein the step of determining the data rate of the second channel comprises the steps of:
determining if a total transmit power is larger than a first transmit power corresponding to the data rate of the first channel when the total transmit power is less than a transmit power limit value;
determining a data rate corresponding to a difference between the total transmit power and the first transmit power as a maximum data rate of the second channel when the total transmit power is larger than the first transmit power; and
determining the data rate of the second channel within the maximum data rate.

28. The method as claimed in claim 27, further comprising the step of interrupting transmission through the second channel when the total transmit power is not larger than the first transmit power.

29. The method as claimed in claim 25, wherein the step of determining the data rate of the second channel comprises the steps of:
determining if the total transmit power is larger than a first transmit power corresponding to the data rate of the first channel when the total transmit power is not smaller than the transmit power limit value;
determining a data rate corresponding to a difference between the total transmit power and the first transmit power as a maximum data rate of the second channel when the total transmit power is larger than the first transmit power; and
determining the data rate of the second channel within the maximum data rate.

30. The method as claimed in claim 29, further comprising the step of interrupting transmission through the second channel when the total transmit power is not larger than the first transmit power.

31. The method as claimed in claim 25, wherein the scheduling assignment information indicates a maximum data rate of the second channel determined based on a difference between the total radio resource and a radio resource corresponding to an average data rate of the first channel, instead of the maximum data rate for a first channel and a second channel.

32. The method as claimed in claim 25, wherein, in the step of determining the total data rate, the total data rate is acquired directly from the scheduling assignment information.

33. The method as claimed in claim 25, wherein, in the step of determining the total data rate, the total data rate is calculated by acquiring a maximum data rate of the second channel and a scheduling optimization coefficient of the UE from the scheduling assignment information and then adding the maximum data rate of the second channel to a product obtained by multiplying the scheduling optimization coefficient by a maximum data rate of the first channel which is received from the radio network controller.

34. The method as claimed in claim 33, wherein the scheduling optimization coefficient corresponds to a-ratio of the average data rate of the first channel with respect to the maximum data rate of the first channel.

35. The method as claimed in claim 25, wherein, in the step of determining the total data rate, the total data rate is calculated by acquiring an average data rate of the first channel and a maximum data rate of the second channel from the scheduling assignment information and then adding the maximum data rate of the second channel and the average data rate of the first channel.

36. The method as claimed in claim 25, wherein, in the step of determining the total data rate, a sum of a maximum data rate of the first channel and a maximum data rate of the second channel is acquired from the scheduling assignment information and the sum is set as the total data rate.

37. The method as claimed in claim 25, wherein, in the step of determining the total data rate, the total data rate is calculated by acquiring a maximum data rate of the second channel from the scheduling assignment information and then adding the maximum data rate of the second channel to a maximum data rate of the first channel which is determined based on a Transport Format Combination Set (TFCS) received from the radio network controller.

38. An apparatus for transmitting uplink data in a mobile communication system supporting an uplink packet data service, the apparatus comprising:
a scheduling assignment information receiver for receiving scheduling assignment information indicating a maximum data rate for a first channel and a second channel;
a controller for determining a data rate for the first channel based on the maximum data rate and determining a data rate for the second channel based on a difference between the maximum data rate and the data rate available of the first channel; and
a transmitter for transmitting the uplink data of the first channel and the second channel using the determined data rate,
wherein the second channel is subjected to scheduling and the first channel is not subjected to scheduling.

39. The apparatus as claimed in claim 38, further comprising a transmit power controller for reducing the transmit power corresponding to the data rate of the second channel, so as to prevent transmit power corresponding to the data rates of the first channel and the second channel from exceeding the transmit power limit value of the UE.

40. The apparatus as claimed in claim 38, wherein the second channel data rate controller performs:
determining if a total transmit power is larger than a first transmit power corresponding to the data rate of the first channel when the total transmit power is less than a transmit power limit value;
determining a data rate corresponding to a difference between the total transmit power and the first transmit power as a maximum data rate of the second channel when the total transmit power is larger than the first transmit power; and
determining the data rate of the second channel within the maximum data rate.

41. The apparatus as claimed in claim 40, wherein the second channel data rate controller interrupts transmission through the second channel when the total transmit power is not larger than the first transmit power.

42. The apparatus as claimed in claim 38, wherein the second channel data rate controller performs:
determining if the total transmit power is larger than a first transmit power corresponding to the data rate of the first channel when the total transmit power is not smaller than the transmit power limit value;
determining a data rate corresponding to a difference between the total transmit power and the first transmit power as a maximum data rate of the second channel when the total transmit power is larger than the first transmit power; and
determining the data rate of the second channel within the maximum data rate.

43. The apparatus as claimed in claim 42, wherein the second channel data rate controller interrupts transmission through the second channel when the total transmit power is not larger than the first transmit power.

44. The apparatus as claimed in claim 38, wherein the scheduling assignment information indicates a maximum data rate of the second channel determined based on a difference between the total radio resource and a radio resource corresponding to an average data rate of the first channel, instead of the maximum data rate for a first channel and a second channel.

45. The apparatus as claimed in claim 38, wherein the scheduling assignment information receiver acquires the total data rate directly from the scheduling assignment information.

46. The apparatus as claimed in claim 38, wherein the scheduling assignment information receiver calculates the total data rate by acquiring a maximum data rate of the second channel and a scheduling optimization coefficient of the UE from the scheduling assignment information and then adding the maximum data rate of the second channel to a product obtained by multiplying the scheduling optimization coefficient by a maximum data rate of the first channel which is received from the radio network controller.

47. The apparatus as claimed in claim 38, wherein the scheduling optimization coefficient corresponds to a ratio of the average data rate of the first channel with respect to the maximum data rate of the first channel.

48. The apparatus as claimed in claim 38, wherein the scheduling assignment information receiver calculates the total data rate by acquiring an average data rate of the first channel and a maximum data rate of the second channel from the scheduling assignment information and then adding the maximum data rate of the second channel and the average data rate of the first channel.

49. The apparatus as claimed in claim 38, wherein the scheduling assignment information receiver acquires a sum of a maximum data rate of the first channel and a maximum data rate of the second channel from the scheduling assignment information and sets the sum as the total data rate.

50. The apparatus as claimed in claim 38, wherein the scheduling assignment information receiver calculates the total data rate by acquiring a maximum data rate of the second channel from the scheduling assignment information and then adding the maximum data rate of the second channel to a maximum data rate of the first channel which is determined based on a Transport Format Combination Set (TFCS) received from the radio network controller.
